(19) United States
(12) Patent Application Publication
(10) Pub. No.: US 2005/0285025 A1
(43) Pub. Date: Dec. 29, 2005

(54) Optical noninvasive pressure sensor

(76) Inventors: Mikhail Boukhny, Laguna Niguel, CA (US); Michael Yadlowsky, Irvine, CA (US); Alexander N. Artsyukhovich, Dana Point, CA (US)

Correspondence Address: ALCON RESEARCH, LTD., R&D COUNSEL, Q-148, 6201 SOUTH FREEWAY, FORT WORTH, TX, 76134-2099, US

(21) Appl. No.: 10/879,789

(22) Filed: Jun. 29, 2004

(51) Int. Cl. G06M 7/00; G01D 5/34

(52) U.S. Cl. 250/231.1; 250/221

(57) ABSTRACT

A system and method for non-invasive pressure sensing are disclosed. One embodiment of the system is an assembly comprising: a plurality of coherent light sources, wherein the plurality of coherent light sources are located in a fixed relationship to one another; an image sensor; and a pressure chamber, comprising a flexible diaphragm, the flexible diaphragm configured to flex in response to a change in pressure in the pressure chamber and operable to reflect a beam of light originating from each of the plurality of coherent light sources onto the image sensor. The pressure sensing assembly can further comprise a processing module operably coupled to the plurality of coherent light sources and to the image sensor and a memory operably coupled to the processing module, wherein the memory includes operational instructions that cause the processing module to carry out the steps of an embodiment of the method for non-invasive pressure sensing of this invention. Such a method can comprise the steps of: directing the plurality of coherent light beams, at a known incidence angle, onto the flexible diaphragm, wherein the plurality of coherent light beams form a pattern of light spots on the diaphragm; capturing at the image sensor an image of the light spot pattern reflected from the diaphragm, wherein the light spot pattern is indicative of the pressure within the pressure chamber; and determining the pressure within the pressure chamber from the captured light spot pattern of the image. The pressure sensing assembly can further comprise a fluidics interface operably coupled to the processor for receiving instructions from the processor to control fluid flow in a fluidics system coupled to the pressure chamber. Such a fluidics interface could be, for example, part of a surgical system, such as an ophthalmic surgical system, incorporating an embodiment of the present invention. The pressure sensing assembly can also comprise a calibration interface for providing calibration inputs to the processor.

### TECHNICAL FIELD OF THE INVENTION

The present invention relates generally to pressure sensors. More specifically, the present invention relates to noninvasive pressure sensors that measure pressure using optical techniques. Even more particularly, the present invention relates to an optical noninvasive pressure sensor that can be used within an ophthalmic surgical system.

### BACKGROUND OF THE INVENTION

It is know to use pressure sensors to measure pressure in various media and in a wide-range of applications, including industrial, commercial, consumer and, in particular, surgical applications. Various devices have been developed for measuring or sensing the pressure in a volume of fluid. Many of these devices have a load cell containing a probe or other sensing apparatus that must physically contact the fluid being measured. While in many mechanical applications (for example, an oil pressure sensor used in an internal combustion engine), physical contact between the probe and the fluid raises no particular concerns, such contact is undesirable in medical applications where the fluid may be a virally or microbially contaminated biological fluid. Under these conditions, if a probe is allowed to contact the biological fluid, the probe must either be discarded or sterilized prior to re-use. Therefore, in medical pressure sensing applications and, in particular, in surgical applications, it is important to use a non-invasive pressure sensor that does not contact the fluid being measured.

Several noninvasive pressure sensors have previously been disclosed in U.S. Pat. Nos. 1,718,494, 2,260,837, 2,510,073, 2,583,941, and 3,805,617, the entire contents of each which are hereby incorporated by reference. These devices use a metal disk within the electromagnetic field of an energized coil to sense pressure changes. As the iron disk moves closer or farther from the coil, the current flow through the coil varies, and these current fluctuations can be used to calculate pressure changes. While these devices are satisfactory for measuring relatively large pressure changes, more minute pressure changes do not cause the current to fluctuate to a sufficient degree to provide an accurate and reliable indicator of pressure variation.

Another basic technique for noninvasive pressure sensing involves the use of a deflectable diaphragm. In such a pressure sensor, a pressure is applied to the diaphragm, either directly or through an isolating medium, and the deflection of the diaphragm is measured. Various deflection measurement techniques can be used. For example, a strain gauge mounted to the diaphragm can provide an indication of deflection. These types of pressure sensors avoid contacting the fluid being tested by using a test chamber separated into two parts by the flexible diaphragm. The fluid body being measured is typically contained on one side of the chamber and the pressure sensor is in communication with the second side of the chamber. Any increase or decrease in the fluid pressure causes the diaphragm to either expand into the second side of the chamber or to be pulled into the fluid part of the chamber, thereby increasing or decreasing the pressure in the second side of the chamber by an amount corresponding to the change in fluid pressure in the first side of the chamber. While these diaphragm type pressure sensors do not invade the test fluid and can be used to detect relatively small pressure changes, the accuracy of such sensors relies to a great extent on the compliance or elastic properties of the diaphragm, properties that can be hard to control during manufacture and that may change over time as the diaphragm is repeatedly stretched and relaxed.

One type of noninvasive pressure sensor that uses a deflectable diaphragm as described above is disclosed in related U.S. patent application Ser. No. 10/610,087, filed Jun. 30, 2003 and entitled “Noninvasive Pressure Sensing Assembly,” the entire contents of which are hereby incorporated by reference. The invention disclosed in the '087 application uses an optical means for measuring the deflection of the diaphragm and relating that deflection to a pressure measurement. The disclosed sensor includes a light source, such as a light emitting diode or normal room illumination, positioned to reflect light off of the surface of a membrane. The membrane is in contact with the fluid in which the pressure is to be measured so that changes in the fluid pressure cause movement of the membrane. A charge-coupled device (CCD) camera captures the reflected light off of the membrane and the reflected light is analyzed to determine the relative movement of the membrane based on the changes in the pattern of the reflected light. Grooves and/or patterns can also be printed on the membrane as means for detecting deflection of the membrane. This type of optical non-invasive pressure sensor, however, requires the focusing and processing of multiple light beams reflected from the membrane as well as the creation and comparison of grating and/or printed patterns reflected from the membrane. These comparisons can lead to inaccuracies and require additional computational power as well as tighter tolerances for the measured reflected light. In particular, this type of optical pressure sensor can be subject to excessive signal noise if the orientation between the grating/pattern and the CCD is inadvertently altered due to thermal or mechanical stress.

Another type of noninvasive pressure sensor, described in PCT Publication WO93/24817 (corresponding to U.S. Pat. No. 5,392,653), uses a flexible diaphragm with an attached magnet. By attaching an iron disk to the diaphragm, the diaphragm is mechanically coupled to a transducer. In order for the transducer to measure the pressure accurately, the diaphragm is made extremely flexible. Nevertheless, variations in the flexibility of the diaphragm affect the accuracy of the pressure measurements. In addition, this assembly relies on firm contact between the magnet and the transducer, variations of which will also affect the accuracy of the pressure measurement. Another noninvasive pressure sensor is disclosed in PCT Publication WO99/23463. This pressure sensor includes a pressure chamber separated from the pressure transducer by a thin compliant membrane. This device, however, relies on the use of a bulky and relatively expensive load cell and stepper motors to position the load cell against the diaphragm.

Therefore, a need exists for an optical noninvasive pressure sensor that can reduce or eliminate the problems associated with prior art noninvasive pressure sensors, such as poor accuracy, poor reliability, and high cost, particularly for pressure sensing applications requiring the noninvasive detection of relatively small pressure changes in a fluid.

### BRIEF SUMMARY OF THE INVENTION

The embodiments of the optical noninvasive pressure sensor of the present invention substantially meet these needs and others. The present invention improves upon prior art pressure sensors by providing an optical noninvasive pressure sensor capable of accurately measuring small pressure changes. In particular, the noninvasive method for pressure detection of the present invention allows for real-time indication of fluid pressure through a robust sensor that is inexpensive to manufacture and employ. The embodiments of the pressure sensor of this invention can be used in any system requiring a fluidics module, such as an ophthalmic surgical system.

One embodiment of the pressure sensor of this invention is a non-invasive pressure sensing assembly comprising: a plurality of coherent light sources, wherein the plurality of coherent light sources are located in a fixed relationship to one another; an image sensor; and a pressure chamber, comprising a flexible diaphragm, the flexible diaphragm configured to flex in response to a change in pressure in the pressure chamber and operable to reflect a beam of light originating from each of the plurality of coherent light sources onto the image sensor. The pressure sensing assembly can further comprise a processing module operably coupled to the plurality of coherent light sources and to the image sensor and a memory operably coupled to the processing module, wherein the memory includes operational instructions that cause the processing module to carry out the steps of an embodiment of the method for non-invasive pressure sensing of this invention. Such a method can comprise the steps of: directing the plurality of coherent light beams, at a known incidence angle, onto the flexible diaphragm, wherein the plurality of coherent light beams form a pattern of light spots on the diaphragm; capturing at the image sensor an image of the light spot pattern reflected from the diaphragm, wherein the light spot pattern is indicative of the pressure within the pressure chamber; and determining the pressure within the pressure chamber from the captured light spot pattern of the image.

The plurality of coherent light sources can, in a preferred embodiment, comprise a first coherent light source and a second coherent light source, providing, respectively, a first light beam and a second light beam. The pressure sensing assembly can further comprise a fluidics interface operably coupled to the processor for receiving instructions from the processor to control fluid flow in a fluidics system coupled to the pressure chamber. Such a fluidics interface could be, for example, part of a surgical system, such as an ophthalmic surgical system, incorporating an embodiment of the present invention. The pressure sensing assembly can also comprise a calibration interface for providing calibration inputs to the processor. Light source optics, for focusing the beams of light originating from the plurality of light sources onto the diaphragm, and imaging optics, for focusing the reflected light beams from the diaphragm onto the image sensor, can be included in the various embodiments of this invention.

Embodiments of the present invention can be implemented to measure pressure in any fluidic system requiring a noninvasive pressure sensor. For example, a surgical system may require such a noninvasive pressure sensor to avoid contamination from a fluid that may have become virally or microbially infected from contact with the patient. One such system is the Infinity Vision Surgical System manufactured by Alcon Laboratories, Inc. of Fort Worth, Tex. for ophthalmic surgery. Other such uses will be apparent to those familiar with the art.

One objective of the present invention is to provide an optical noninvasive pressure sensor. Another objective of the present invention is to provide a relatively inexpensive pressure sensor. Still another objective of the present invention is to provide a pressure sensor that can measure pressures less than ambient pressure. These and other advantages and objectives of the present invention will become apparent from the detailed description, drawings and claims that follow.

### BRIEF DESCRIPTION OF THE SEVERAL VIEWS OF THE DRAWINGS

A more complete understanding of the present invention and the advantages thereof may be acquired by referring to the following description, taken in conjunction with the accompanying drawings, in which like reference numbers indicate like features and wherein:

FIG. 1 is a simplified block diagram of a noninvasive optical pressure sensor according to one embodiment of the present invention;

FIG. 2 is a simplified block diagram of the noninvasive optical pressure sensor of FIG. 1 at a lower applied pressure;

FIG. 3A and FIG. 3B are simplified block diagrams illustrating the ability of the embodiments of this invention to compensate for deviations from a reference diaphragm;

FIG. 4 is a simplified block diagram illustrating a method for calibrating the incidence angle of light beams onto a diaphragm of an embodiment of this invention;

FIG. 5 is a simplified block diagram illustrating a method for precisely calculating the angle at which the laser/light beam is incident upon the diaphragm of an embodiment of this invention.

FIG. 6 is a simplified drawing of a coordinate system defined to calculate the change in the angle of incidence of a light beam incident on a diaphragm of an embodiment of this invention;

FIG. 7 illustrates a method of creating a look-up table to determine pressure chamber pressures from diaphragm deflections;

FIG. 8 is a simplified block drawing illustrating the various opto-mechanical components of an embodiment of this invention;

FIG. 9 is a simplified diagram illustrating the ability of the embodiments of this invention to tilt an image sensor to maintain spot focus as the diaphram deflects with pressure changes; and

FIG. 10 is a graph illustrating a calibration curve for a pressure sensor implemented in accordance with this invention.

### DETAILED DESCRIPTION OF THE INVENTION

Preferred embodiments of the present invention are illustrated in the FIGUREs, like numerals being used to refer to like and corresponding parts of the various drawings.

The various embodiments of the present invention provide for a noninvasive optical pressure sensor that can be used in any system requiring pressure measurement, and in particular, in a fluidics system in which it is necessary to measure pressure. The embodiments of the present invention are especially suited for use in surgical machines, or systems, such as an ophthalmic surgical system, in which it is desirable to measure the pressure of a possibly contaminated fluid.

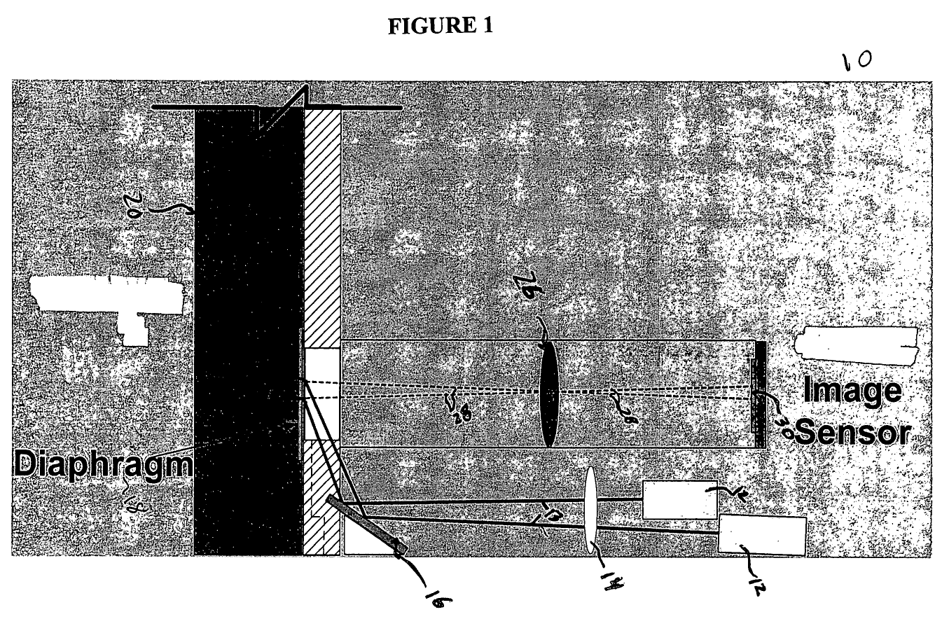

FIG. 1 is a simplified block diagram of a noninvasive optical pressure sensor according to one embodiment of the present invention. The pressure sensor can generally include light sources 12, source lens 14, mirror 16, pressure chamber 20, flexible membrane 18, imaging lens 26, and image sensor 30. Other embodiments can comprise a single light source 12. A single light source 12 or multiple light sources 12 can also be focused directly onto flexible membrane 18. As will be further apparent to those familiar with the art, other optical elements can be used to form an optical path between light source 12 and diaphragm 18 to focus the light from light source 12 onto diaphragm 18.

Pressure chamber 20 can contain the fluid having a pressure to be measured and may be made of any suitable material, such as metal, glass, or plastic, and may be of any suitable size or shape and can contain a port(s) (not shown) through which the pressure within chamber 20 may be varied. Diaphragm 18 is a flexible member that can be made of any suitably compliant material having good dimensional stability, such as stainless steel. Diaphragm 18 can further be a flat diaphragm, a pre-curved diaphragm (concave or convex) or a corrugated diaphragm. Diaphragm 18 should have a consistent texture (if present) across the portion of its surface that may receive incident light from a light source 12. Light sources 12 can be any of a variety of commercially available light sources, such as a laser, laser diode, or LEF, but preferably a laser diode as known in the art.

Light sources 12 provide beams of light 13, which are directed to pass through focusing lens 14 and onto mirror 16. Mirror 16 reflects light beams 13 onto diaphragm 18. At diaphragm 18, light beams 13 are focused as spots 22 and 24 on diaphragm 18 and are reflected as light beams 28, corresponding to the reflected images of spots 24 and 22 from diaphragm 18. Light beams 28 pass through lens 26. Lens 26 focuses light beams 28 on image sensor 30. Image sensor 30 captures the reflected images of spots 24 and 22 and, in particular, the spatial separation between spots 24 and 22. Image sensor 30 can be any of a variety of commercially available devices such as a CCD (charge-coupled device) or a CMOS (complementary-metal-oxide semiconductor) image sensor, or even a PD (photo sensitive diode) capable of capturing and differentiating between the reflected images of spots 24 and 22.

As shown in FIG. 1, light beams 13 are focused by source lens 14 onto mirror 16, which redirects light beams 13 onto diaphragm 18, forming spots 24 and 22. Light beams 13 are directed onto diaphragm 18 at a set incidence angle by mirror 16. Spots 24 and 22 are reflected off of diaphragm 18 as light beams 28 and refocused at image sensor 30 via imaging lens 26. When the pressure within chamber 20 is at or near a reference pressure (e.g., ambient pressure), then as shown in FIG. 1, diaphragm 18 will be at a preset reference position (e.g., flat as shown). In FIG. 1, the reference position of diaphragm 18 is shown as flat for purposes of illustration, but the diaphragm 18 reference position can be any arbitrarily determined reference position at which the pressure sensor is calibrated for a reference pressure, such as ambient pressure.

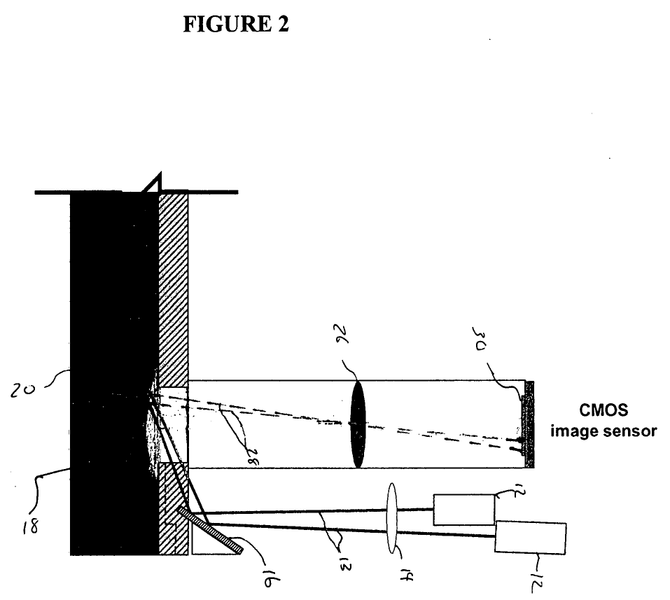

Based on the relative positions of lights 12 to one another (a known and fixed relationship) and the angle of incidence for light beams 13 provided by mirror 16, spots 24 and 22 formed by reflected light beams 13 will be separated by a preset amount (i.e., have a fixed initial separation at a reference diaphragm position). The separation between spots 24 and 22 will be reproduced and detected at image sensor 30 (in the embodiment shown, this is done via imaging lens 26, which focuses the reflection of spots 22 and 24 on the image sensor 30). When the pressure within chamber 20 is below the set reference pressure (e.g., ambient pressure), as shown in FIG. 2, diaphragm 18 will be deflected inward (become concave), causing the position of spots 22 and 24, both on the diaphragm and relative to one another, to change. The change in diaphragm position and in relative spatial separation between spots 22 and 24 is reproduced and detected at image sensor 30, as previously described. One skilled in the art will recognize that in a similar manner, pressure changes in chamber 20 above the reference pressure will cause diaphragm 18 to become convex (not shown), causing a shift in the position of spots 22 and 24 in a direction opposite to that of when pressure drops below the reference pressure, with a corresponding change in the separation between spots 22 and 24. The change in position of spots 22 and 24 will similarly be reproduced and detected at image sensor 30.

Thus, following a change in pressure, the change in relative separation and in diaphragm position of spots 22 and 24 is detected and captured by image sensor 30, and can then be analyzed using software well known in the art to calculate the displacement of diaphragm 18. The displacement of diaphragm 18 can then be correlated to a corresponding change in pressure. The displacement of diaphragm 18 as indicated by the position changes of spots 22 and 24, directly relates to the pressure and pressure changes within chamber 20.

An alternative embodiment of the present invention can use a single light source 12 to shine a single spot onto diaphragm 18. As the pressure in chamber 20 changes, diaphragm 18 will deflect as previously described and the change in the relative position of the single spot on diaphragm 18 can be correlated to the change in pressure in chamber 20. Alternative embodiments can also include directing the light source or sources 12 directly onto diaphragm 18 without the optical components (path) formed by lens 14 and mirror 16. For example, a focusing assembly, such as a lens or a simple pinhole, can be incorporated into each light source 12. Other focusing means for directing light from light sources 12 onto diaphragm 18 (and/or from diaphragm 18 onto image sensor 30) will be known to those familiar with the art and are contemplated as being within the scope of this invention. A more detailed explanation for determining the angle of incidence of light beams 13 onto diaphragm 18 and for calibrating a pressure sensor of the present invention (i.e., determining reference positions and values) are provided later below.

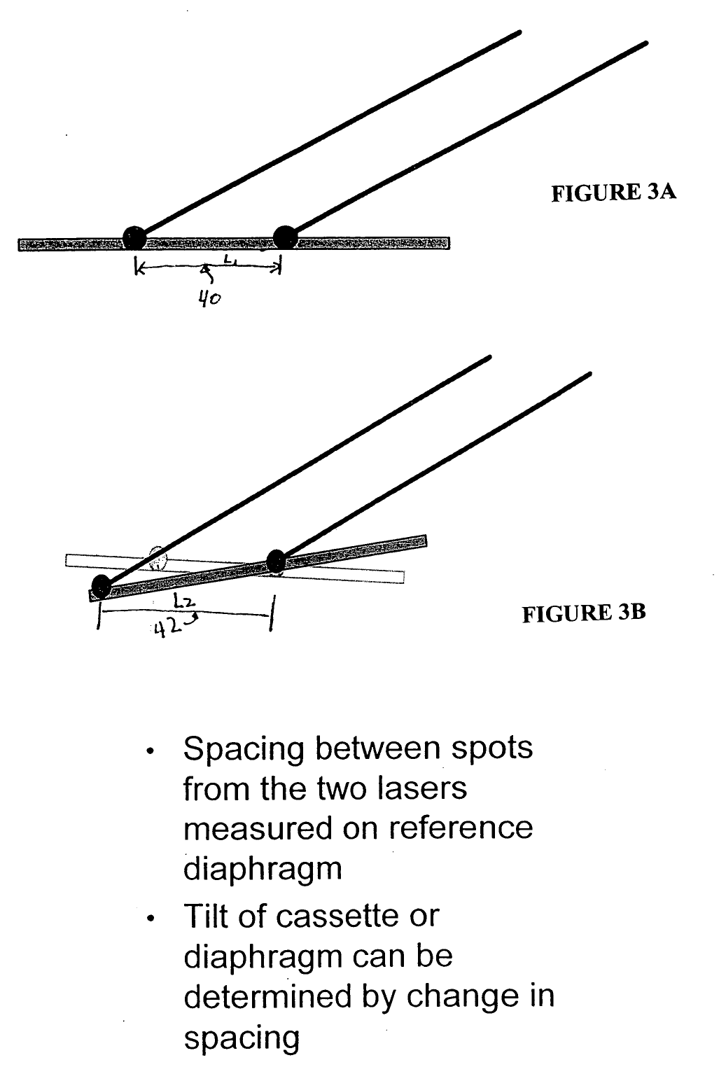

FIGS. 3A and 3B illustrate how the embodiments of this invention can compensate for a change in the orientation of diaphragm 18 or chamber 20 from a reference position. Such a change in orientation might be caused, for example, by a variation in fit of a replaceable fluidics module in an ophthalmic surgical system. Such systems can use a replaceable fluidics cassette which can comprise a pressure chamber having a diaphragm, corresponding to chamber 20 and diaphragm 18 of FIG. 1. As shown in FIG. 3A, when diaphragm 18 (chamber 20) is at a reference position (here shown as a flat diaphragm 18 and a chamber 20 oriented to a reference position), spots 22 and 24 on diaphragm 18 are separated by a first separation indicated by Line 40. In the event the initial position of a chamber 20 and diaphragm 18 changes from the reference position prior to a pressure measurement being made (e.g., due to a tilt from the reference position when a new replaceable chamber is inserted), then as shown in FIG. 3B, the new position of spots 22 and 24 on diaphragm 18 can be measured and the tilt in the chamber 20/diaphragm 18 from the reference position can be compensated for prior to pressure measurements being made. This can be done, for example, as part of a calibration routine.

As when detecting changes in pressure during normal operation, image sensor 30 can be used to detect the change in the linear separation between spots 22 and 24 due to a tilt as described above and provide this information to a processing system to compensate for the tilt. Such a processing system can comprise a processor, a memory and computer executable software instructions stored within the memory and capable of being executed by the processor. A processing system in accordance with the teachings of this invention is described more fully later below. Software for correlating the change in separation of spots 24 and 22 to the change in pressure within a chamber 20, or to a change in reference position due to variations between replaceable chambers, will be known to those familiar with the art. Any such software can be used with the embodiments of the present invention.

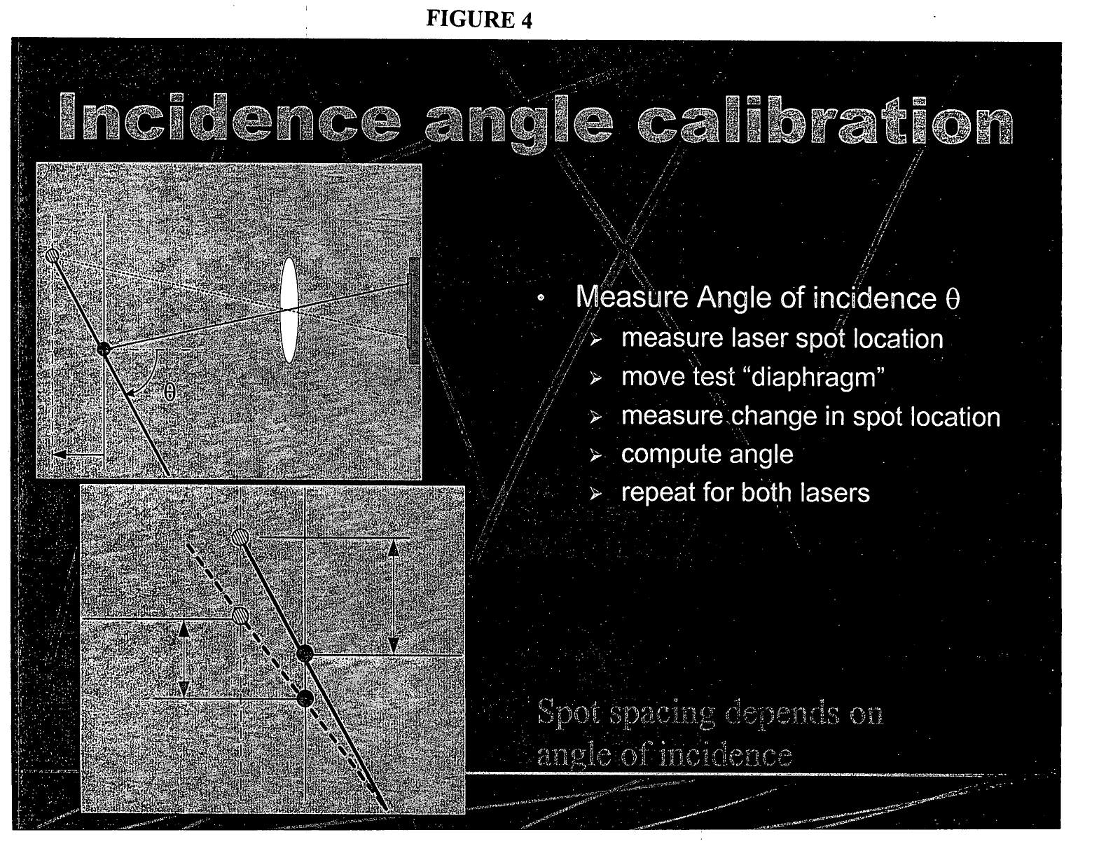

FIG. 4 is a simplified diagram illustrating a method for calibrating the incidence angle of light beams 13 onto diaphragm 18 (which form spots 22 and 24). It is necessary to know the angle of incidence of light beams 13 onto diaphragm 18 because the spacing of spots 22 and 24 on diaphragm 18 depends on the angle of incidence of the light beams 13. To determine the angle of incidence, the location of a spot, such as spot 22 of FIG. 1, is measured on a reference diaphragm, such as previously described above. The diaphragm 18 is then deflected from the reference position to a test position and the change in spot location is measured. Using well-known mathematical formulas, the angle of incidence is computed and the process is repeated for each light source 12 as needed. In this way, the angle of incidence of the light beams 13 onto diaphragm 18 is known.

As discussed above, one embodiment of this invention can be implemented to measure pressure in a surgical cassette of a surgical system. Such a cassette can include a chamber 20 bounded by a diaphragm 18 that is connected to the aspiration line of the fluidics portion of the corresponding surgical system. One side of the diaphragm 18 can be exposed to the ambient air pressure. The diaphragm 18 will deform as described above in response to pressure differences between the aspiration line and ambient pressure.

In each embodiment of this invention, the relationship between diaphragm 18 deformation and pressure difference is monotonic (or very nearly so). Thus, measurement of the diaphragm 18 deformation can be used to infer the chamber 20 pressure based on a calibration relationship or table. The diaphragm 18 deformation can be uniquely quantified as the deflection of its center. This can be determined by projecting the narrow beams of light 13, which preferably are generated by a laser light source, onto the surface of the diaphragm 18 at an oblique angle and imaging the resulting scattered light spots 22 and 24 on an image sensor 30 (e.g. a CCD or CMOS image sensor chip).

The location of the image of the spot can be quantitatively determined from the image data or a sub-set of the image, such as one or a few lines of pixel data, using one of a number of techniques. Options for quantifying the location of the peaks include determining the center of mass of the spot, correlating the image with a reference shape and finding the peak of the result, or fitting a curve to the data and determining the shift required to minimize the error of the fit. The correlation technique is preferred because it can be made to work with different beam shapes (including asymmetric beams), is effective at suppressing or averaging out noise and can be implemented efficiently with a digital signal processor.

Initially the laser spots' 22 and 24 location is measured for a reference pressure (such as ambient, or no net pressure difference). Pressure measurements are made by comparing the location of the laser spots 22 and 24 on the image sensor 30 for that pressure condition to their position for the reference pressure (or alternatively, directly through the use of the absolute location of the spots 22 and 24 images on the image sensor 30, compared to known landmarks on the image sensor and/or the diaphragm 18). For time critical applications, the relative motion of the spots 22 and 24 can be directly converted to pressure using a pre-computed look-up table as described below.

A number of elements must be considered to make the pressure sensor of this invention accurate and robust. First, it is important to know the angle (or average angle) at which a light beam 13 is incident on the diaphragm 18. For some applications it is desirable to know the incidence angle to an accuracy of approximately 1°. At the same time, it is difficult to insure that the orientation of the diaphragm 18 with respect to the chamber 20 and the position of the chamber 20 with respect to a fluidics mechanism in which it may be implemented will be reproducible enough to insure that this condition will hold, in particular in the case where the chamber 20 and diaphragm 18 are implemented as a replaceable unit. Therefore, it is necessary to precisely measure the angle of incidence of the light beams 13 with respect to a reference diaphragm 18 when a system implementing an embodiment of this invention is manufactured and then measure changes in these angles each time a new chamber 20/diaphragm 18 unit is inserted in the system for a surgical procedure or session.

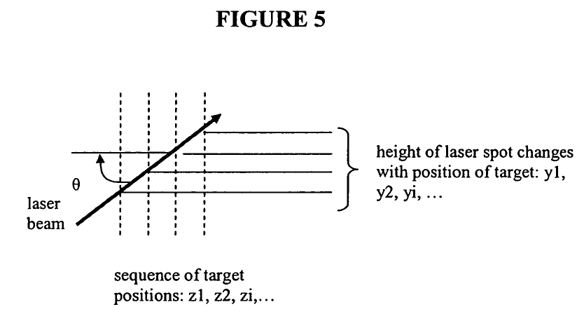

At time of assembly, the angle of incidence of a light beam 13 with respect to the normal of a flat (or other reference position) diaphragm 18 can be measured in several different ways. In the first method, a diaphragm 18 or test target is moved towards or away from the image sensor 30 in precisely measured increments that approximately span the range of positions that the diaphragm 18 may occupy during actual pressure measurements. As shown in FIG. 5, the height (y) of a laser spot such as spot 22 or 24 as a function of position of a target location (z) can then be used to precisely calculate the angle (θ) at which the laser/light beam is incident upon the diaphragm. This can be done by regressing the height of the spot in diaphragm coordinates against the location of the optical spot on the target using a well know least squares approach. The arc tangent of the slope of the line relating beam height to target spacing gives the angle of incidence.

Alternatively, a series of known pressures can be applied to the diaphragm 18 and the resulting position of the spot on the diaphragm 18 can be recorded. The response of the diaphragm 18 (deflection as a function of pressure) must be known in advance. The angle of incidence can then be determined by comparing the spot location on diaphragm 18 measured for each pressure to the predictions of a model (described below) that relates the location of the spot on the diaphragm 18 to the angle of incidence of the beam 13. The angle of incidence is determined by numerically solving for the angle that best aligns the model to the data.

One or both of the above procedures can be used during the manufacture of an embodiment of the pressure sensor of this invention to establish a reference angle of incidence for any light source 12 within the system. Accurate pressure measurements (e.g. accuracy of the greater of 10 mm Hg or 10%), however, require that the incidence angle be updated each pressure measuring session. This can be done by using two or more light sources. By measuring the locations of the two spots 22 and 24 at some reference pressure (e.g. no applied pressure) at manufacture time, instrument reference positions can be determined for each spot. When a system implementing a pressure sensor in accordance with this invention is used in the field, the positions of each of the laser spots can again be determined for a known pressure, such as P=0 mm Hg or ambient. These session reference locations are compared to the original reference locations. The two (or more) spots provide additional information that can be used to determine changes in both the angle of incidence of the light from the light sources 12 (more precisely, the angle of incidence with respect to the plane that contains the two light beams 13) and the distance between the diaphragm 18 and the instrument itself.

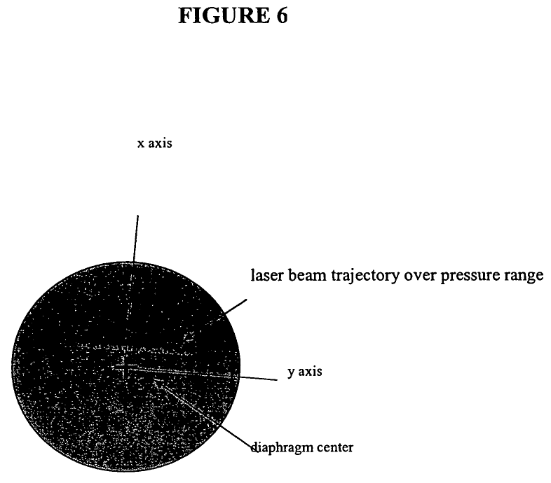

To calculate the change in the angle of incidence, it is helpful to define a coordinate system. As shown in FIG. 6, this can be done by setting the y axis parallel to the direction of beam motion with changes in pressure/diaphragm 18 position and the x axis perpendicular to the y axis, but in the plane of the diaphragm 18. For the case of two light sources 12, the y-component of the instrument reference spot locations can be designated as y10 and y20. The corresponding components of the spot positions for the session references can be designated as y11 and y21. If the angle between the two laser beams is assumed to not change (i.e., any change that occurs is small compared to their common change in angle of incidence with respect to the diaphragm) due to manufacturing tolerances and variability of the positioning of the chamber 20 in the instrument, then the change in the angle of incidence δθ for the session configuration relative to the instrument reference is given by

$$tan δ θ = \frac{( {y}_{21} - {y}_{20} ) cot ( {θ}_{2} ) - ( {y}_{11} - {y}_{10} ) cot ( {θ}_{1} )}{{y}_{20} - {y}_{10}} \qquad EQUATION 1$$

where θ₁ and θ₂ are the angles of incidence of beams 1 and 2 (from two light sources 12) respectively.

Once the angle of incidence has been measured for a particular unit containing a chamber 20 (installed for a particular session), a look-up table can be produced to directly relate pressure to the relative position of a laser spot. The direct relationship between spot location and pressure is difficult to calculate. However, it is possible to readily determine the spot location and pressure associated with a particular deflection of the vertex of the diaphragm 18. Therefore, a convenient method for developing the look-up table is to start with a somewhat arbitrary, but dense array of z-plane deflection values (Δz) for the diaphragm 18 that range from the lowest to highest deflections that a system implementing an embodiment of the pressure sensor of this invention is intended to support. For example, if under the conditions of interest the diaphragm 18 vertex may move from −0.3 mm to 0.7 mm, it is desirable to have on the order of 100 or more points, so that the Δz array can correspond to 10 μm steps in position and include 101 points −0.3 mm, −0.29 mm, −0.28 mm, . . . , 0.69 mm, 0.7 mm.

The pressure associated with different vertex deflections can be measured by applying a series of calibrated pressures to the diaphragm 18 and measuring the deflection of the center of the diaphragm 18 using either a mechanical probe or an optical technique, such as the processes described herein (laser spot position can be readily converted to equivalent diaphragm 18 deflection if the angle of incidence is known). The pressures corresponding to the array of Δz values described above can be computed by interpolating between the data points of the measured diaphragm 18 pressure response curve.

At the same time, the location where a light beam 13 would hit the diaphragm for each of the diaphragm 18 deflections Δz can be calculated by using the well known theory of exact ray tracing, as described, for example, on p. 309 of Modern Optical System Design, 3^{rd} Edition, by Warren Smith. To use this ray analysis, the diaphragm 18 is assumed to assume an approximately spherical shape in response to an applied pressure. The curvature, c, of the diaphragm 18 can be approximated as

$$c = \frac{- 3.333 * Δ z}{Δ {z}^{2} + {a}^{2}} \qquad EQUATION 2$$

where “Δz” is the deflection of the vertex of the diaphragm 18 and “a” is the radius of the diaphragm 18. The factor of 3.333 in the numerator is used in this case instead of 2 to account for the fact that the effective radius of the diaphragm 18 is smaller than its physical size because the fixed edge of the diaphragm 18 only allows its center portion to move. The ray trace procedure indicates where a light beam 13 will hit the diaphragm 18. This position can either be used directly or converted to a relative position (Δy) by comparing it to the position associated with the reference position where, for example, pressure chamber 20 is at zero pressure.

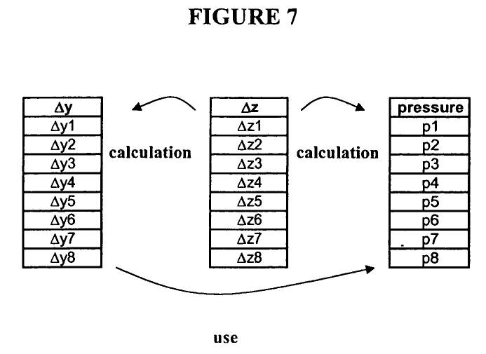

Using the procedure described above, it is possible to calculate both the laser spot 22 and 24 locations (Δy) and the pressures associated with each of the initial values of the Δz array, shown in FIG. 7. Once the Δy values and the pressures have been calculated, they form a look-up table that relates relative laser spot 22 and 24 position to pressure. For ease in looking up values, interpolation can be used to place the Δy values on a regular spacing. Pressure measurements can then be made by determining the location of the laser spot(s) 22 and 24 and using the look up table to convert this position or relative position to a pressure. This process can be performed by a processor operably connected to the image sensor 30.

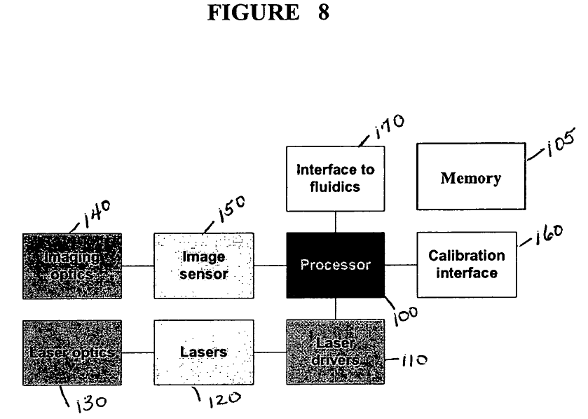

Embodiments of a pressure measurement system in accordance with this invention generate the light beams 13, image the location of the light beams 13 scattering from the surface of the diaphragm 18, determine the location of the imaged spots 22 and 24, process the information as described above, and store calibration information. FIG. 8 shows another embodiment of a pressure sensing assembly of the present invention, illustrating in block form the various elements for performing the above-described functions.

As shown in FIG. 8, Processor 100 is a central processing unit for coordinating the various functions of a system in accordance with this invention. Processor 100 can provide an input to light source drivers 110, as well as receive as an input information from light source drivers 110, for example, during a calibration procedure. Processor 100 can process the light spot 22 and 24 positional information received from image sensor 150 (corresponding to image sensor 30 of FIG. 1) and determine the pressure within chamber 20 in a manner as previously described. Processor 100 can provide the derived pressure information to a fluidics system of, for example, an ophthalmic surgical system, via a fluidics interface 170. Such information can be used by the surgical system to control various flows within the fluidic system, such as aspiration flow. Calibration interface 160 can be used for calibrating the pressure sensor, as previously described.

A memory 105 is operably coupled to processor 100 and is operable to store computer executable software instructions for performing the various steps of the embodiments of the methods of this invention. Imaging optics 140 can comprise any optics as required for a given implementation (e.g., imaging lens 26) as can light source optics 130 (e.g., source lens 14). Light sources 120 correspond to light sources 12 of FIG. 1 and can comprise any such light source as described herein.

Processor 100 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 105 may be a single memory device or a plurality of memory devices. Such a memory device may be a read-only memory, random access memory, volatile memory, non-volatile memory, static memory, dynamic memory, flash memory, and/or any device that stores digital information. Note that when the processor 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. The memory 105 stores, and the processor 100 executes, operational instructions corresponding to at least some of the steps and/or functions illustrated in FIGS. 1-9.

In a particular embodiment, the memory 105 is operably coupled processor 100 and includes operational instructions that cause the processor 100 to direct (e.g., via the light source drivers 110) a plurality of coherent light beams, at a known incidence angle, onto a flexible diaphragm, wherein the flexible diaphragm forms a portion of a pressure chamber and is configured to flex in response to a change in pressure in the pressure chamber and wherein the plurality of coherent light beams form a pattern of light spots on the diaphragm; capture at an image sensor an image of the light spot pattern reflected from the diaphragm, wherein the light spot pattern is indicative of the pressure within the pressure chamber; and determine the pressure within the pressure chamber from the captured light spot pattern image. Memory 105 can further include operational instructions that cause the processor 100 to calibrate itself at a reference pressure by associating a reference light spot pattern to a reference diaphragm position corresponding to the reference pressure.

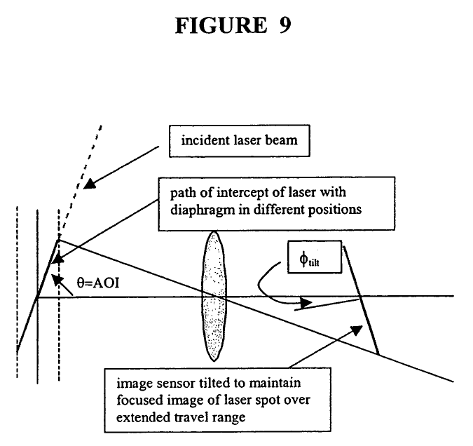

Returning to FIG. 1, the opto-mechanical portion of an embodiment of the pressure sensor of this invention is shown. A diaphragm 18 can be imaged in sharp focus for a range of diaphragm 18 positions. As the diaphragm 18 deflects due to changing pressures within chamber 20, the image of the spots 22 and 24 on the image sensor 30 can blur, making it harder to determine the precise location of the spots 22 and 24. This can be compensated somewhat by tilting the image sensor 30 such that a hypothetical extended object occupying the same space as the incident light beams 13 would be in focus at the image sensor 30. This is illustrated schematically in FIG. 9. The tilt of image sensor 30 can be a predetermined amount, or can be adjustable based on the particular application of the pressure sensor.

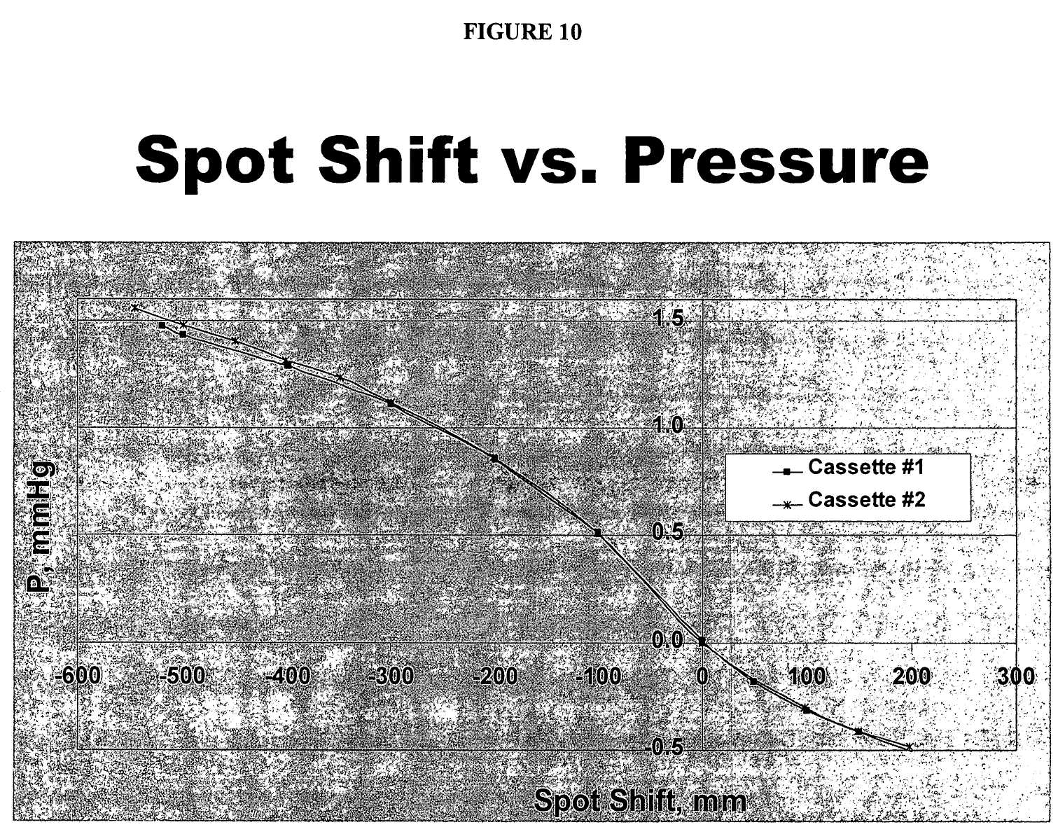

FIG. 10 is a graph illustrating one calibration curve for pressure (mm Hs) to the spot shift on diaphragm 18 in millimeters. The spot shift in this case is a change in the linear separation between spots 24 and 22. Curves such as shown in FIG. 10 can be generated so that appropriate software can be used to correlate the change in distance between spots 24 and 22 to a corresponding change in pressure within chamber 20. These generated curves can be different for different pressure sensors implemented in accordance with this invention.

The embodiments of the pressure sensor of the present invention can measure pressure in a range from about minus 700 mm Hg to about 150 mm Hg. The embodiments of this invention can provide this range of measurement with accuracy approximately that of the greater of +/−10% of the range or 10 mmHg. Further, peak detection capabilities of the embodiments of this invention encompass, for low pressure, up to 50 mm, and for high pressure, 70 mm. This can be achieved by straightforward location of a pixel at image sensor 30 where the signal (received light intensity) is the highest.

Pressure sensing assembly 10 of the present invention thus allows for the noninvasive measurement of pressure within a chamber 20 by optical means. One skilled in the art will also recognize that by varying the thickness of diaphragm 18, the optical properties of lenses 14, 26, or mirror 16 and/or the relative position of these components, the pressure range that can be detected by noninvasive pressure sensor 10 can be adjusted for a particular implementation

Although the present invention has been described in detail herein with reference to the illustrated embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons ordinarily skilled in the art having reference to this description. It is contemplated that all such changes in additional embodiments are within the spirit and true scope of this invention as claimed below. Thus, while the present invention has been described in particular reference to the general area of fluidic surgical systems, the teachings contained herein apply equally where ever it is desirous to provide noninvasive pressure sensing to avoid, for example contact with a contaminated fluid.

1. A non-invasive pressure sensing assembly, comprising:
a plurality of coherent light sources, wherein the plurality of coherent light sources are located in a fixed relationship to one another;
an image sensor; and
a pressure chamber, comprising a flexible diaphragm, the flexible diaphragm configured to flex in response to a change in pressure in the pressure chamber and operable to reflect a beam of light originating from each of the plurality of coherent light sources onto the image sensor.

2. The assembly of claim 1, wherein the beams of light are reflected by the diaphragm in a pattern indicative of the pressure within the pressure chamber and wherein the image sensor is operable to capture the pattern of the reflected light beams.

3. The assembly of claim 2, wherein the pattern of the reflected beams of light indicates the spatial relationship between the beams of light incident on the diaphragm.

4. The assembly of claim 3, wherein the plurality of coherent light sources comprises a first coherent light source and a second coherent light source, providing, respectively, a first light beam and a second light beam.

5. The assembly of claim 2, further comprising a processor operable to receive the captured pattern of the reflected light beams and to determine therefrom the pressure within the pressure chamber.

6. The assembly of claim 5, further comprising computer executable software instructions operable to cause the processor to determine the pressure within the pressure chamber from the pattern of the reflected light beams.

7. The assembly of claim 5, further comprising a fluidics interface operably coupled to the processor for receiving instructions from the processor to control fluid flow in a fluidics system coupled to said pressure chamber.

8. The assembly of claim 5, further comprising a calibration interface for providing calibration inputs to the processor.

9. The assembly of claim 1, further comprising imaging optics for focusing the reflected light beams from the diaphragm onto the image sensor.

10. The assembly of claim 9, wherein the imaging optics comprises a lens.

11. The assembly of claim 1, further comprising light source optics for focusing the beams of light originating from the plurality of light sources onto the diaphragm.

12. The assembly of claim 11, wherein the light source optics comprise a lens and a mirror.

13. The assembly of claim 12, wherein the mirror reflects the beams of light from the plurality of light sources onto the diaphragm at a known angle of incidence.

14. The assembly of claim 13, wherein the assembly is calibrated for a reference diaphragm position and the known angle of incidence.

15. The assembly of claim 1, wherein the light beams are incident on the diaphragm at a known angle of incidence.

16. The assembly of claim 15, wherein the assembly is calibrated for a reference diaphragm position and the known angle of incidence.

17. The assembly of claim 16, wherein the reference diaphragm position corresponds to a reference pressure in the pressure chamber.

18. The assembly of claim 1, wherein the plurality of light sources are laser diodes.

19. The assembly of claim 1, wherein the plurality of light sources are laser light sources.

20. The assembly of claim 1, wherein the image sensor is a CMOS image sensor.

21. The assembly of claim 1, wherein the image sensor is a charge-coupled device.

22. The assembly of claim 1, wherein the diaphragm is formed from stainless steel.

23. The assembly of claim 1, wherein the plurality of coherent light sources comprises a first coherent light source and a second coherent light source, providing, respectively, a first light beam and a second light beam.

24. The assembly of claim 1, wherein the pressure chamber and diaphragm are formed as a replaceable cassette.

25. The assembly of claim 1, wherein the assembly is operably coupled to a fluidics system of an ophthalmic surgical system.

26. A method for non-invasive pressure sensing, comprising:
directing a plurality of coherent light beams, at a known incidence angle, onto a flexible diaphragm, wherein the flexible diaphragm forms a portion of a pressure chamber and is configured to flex in response to a change in pressure in the pressure chamber and wherein the plurality of coherent light beams form a pattern of light spots on the diaphragm;
capturing at an image sensor an image of the light spot pattern reflected from the diaphragm, wherein the light spot pattern is indicative of the pressure within the pressure chamber; and
determining, at a processor operably coupled to receive image data from the image sensor, the pressure within the pressure chamber from the captured light spot pattern image.

27. The method of claim 26, wherein the light spot pattern indicates the pressure within the pressure chamber relative to a reference light spot pattern resulting from a reference position of the diaphragm corresponding to a reference pressure.

28. The method of claim 27, further comprising calibrating the processor at the reference pressure by associating the reference light spot pattern to the reference diaphragm position corresponding to the reference pressure.

29. The method of claim 26, wherein the plurality of coherent light beams are provided by a plurality of coherent light sources.

30. The method of claim 29, wherein the plurality of coherent light sources are laser light sources.

31. The method of claim 26, wherein the plurality of light beams is two light beams.

32. The method of claim 26, wherein the determining step is performed by computer executable software instructions operable to cause the processor to determine the pressure within the pressure chamber from the light spot pattern image.

33. The method of claim 26, further comprising the step of providing instructions from the processor to a fluidics interface operably coupled to the processor for controlling fluid flow in a fluidics system coupled to the pressure chamber.

34. The method of claim 26, wherein the processor further comprises a calibration interface for providing calibration inputs to the processor.

35. The method of claim 26, further comprising the step of focusing the reflected light spot pattern on the image sensor through imaging optics.

36. The method of claim 35, wherein the imaging optics comprise a lens.

37. The method of claim 26, further comprising the step of focusing the plurality of coherent light beams onto the diaphragm through light source optics.

38. The method of claim 37, wherein the light source optics comprise a lens and a mirror.

39. The method of claim 38, wherein the mirror directs each of the plurality of beams of light onto the diaphragm at the known incidence angle.

40. The method of claim 26, wherein the image sensor is a CMOS image sensor.

41. The method of claim 26, wherein the image sensor is a charge-coupled device.

42. The method of claim 26, wherein the diaphragm is formed of stainless steel.

43. The method of claim 26, wherein the pressure chamber and the diaphragm are formed as a replaceable cassette.

44. The method of claim 43, wherein the method is implemented to sense pressure in an ophthalmic surgical system.

45. A non-invasive pressure sensing assembly, comprising:
a plurality of coherent light sources, wherein the plurality of coherent light sources are located in a fixed relationship to one another;
an image sensor;
a pressure chamber, comprising a flexible diaphragm, the flexible diaphragm configured to flex in response to a change in pressure in the pressure chamber and operable to reflect a beam of light originating from each of the plurality of coherent light sources onto the image sensor;
a processing module operably coupled to the plurality of coherent light sources and to the image sensor; and
a memory operably coupled to the processing module, wherein the memory includes operational instructions that cause the processing module to:
direct the plurality of coherent light beams, at a known incidence angle, onto the flexible diaphragm, wherein the plurality of coherent light beams form a pattern of light spots on the diaphragm;
capture at the image sensor an image of the light spot pattern reflected from the diaphragm, wherein the light spot pattern is indicative of the pressure within the pressure chamber; and
determine the pressure within the pressure chamber from the captured light spot pattern image.
